(19) United States
(12) Patent Application Publication
(10) Pub. No.: US 2007/0012799 A1
(43) Pub. Date: Jan. 18, 2007

(54) Broadcast spreader metering rate control system

(76) Inventor: Jeffrey D. Kendall, Laurel, MD (US)

Correspondence Address: WOODARD, EMHARDT, MORIARTY, MCNETT & HENRY LLP, 111 MONUMENT CIRCLE, SUITE 3700, INDIANAPOLIS, IN, 46204-5137, US

(21) Appl. No.: 11/488,496

(22) Filed: Jul. 18, 2006

Related U.S. Application Data
(60) Provisional application No. 60/700,156, filed on Jul. 18, 2005.

(51) Int. Cl. A01G 25/09; B05B 1/20; B05B 9/03

(52) U.S. Cl. 239/146; 239/159; 239/164

(57) ABSTRACT

A broadcast spreader incorporates a metering rate control system for maintaining a uniform dispersal or spreading of material such as fertilizer or similar material. The spreader includes a material hopper having a bottom orifice through which material to be dispersed passes. A control gate is positioned at the hopper orifice and is opened or closed to allow material to exit the spreader hopper. The rate control system adjusts and maintains the position of the control gate in order to ensure that the desired amount of material is dispersed or spread regardless of environmental or material conditions that would otherwise impede or change the flow characteristics of the material.

### REFERENCE TO RELATED APPLICATION

This application claims priority from a Provisional Application Ser. No. 60/700,156, filed Jul. 18, 2005, which is hereby incorporated by reference.

### BACKGROUND

The lawn care or landscape maintenance industry uses spreaders to apply products, such as fertilizer and other granulated material, to maintain and promote a healthy lawn, for example. Often the landscaper or lawn care worker must apply these products to a lawn in a climate that changes over the course of a calendar year. For example, in some geographic areas the spring season may have a climate with relatively low humidity and low temperatures compared to its summer season that may have a climate with relatively high humidity and high temperatures. The level of humidity typically affects the fertilizer or granulated material in the spreader such that the fertilizer or granulated material will clot or clump up in the spreader, thereby making it difficult for the material to pass through the spreader to be distributed onto a lawn. Often spreaders have a shut-off plate or control gate that controls the rate that a fertilizer is applied to a lawn. The shut-off plate is often attached, to and controlled by, a solenoid which may work in combination with a spring. However, it is often difficult to balance the rate of closure of the shut-off plate spring with the opening power of the solenoid in both in humid climates (where the fertilizer becomes sticky) and dry climates (where the fertilizer remains granular). In these situations, too much solenoid power, or too weak a spring, may prevent the spring from efficiently closing the shut-off plate in dry weather, while too little solenoid power, or too strong a spring, may not allow the shut-off plate to open properly in humid weather. Either situation may result in an improper amount of material being spread or applied. For that reason, spreaders having a solenoid and spring combination have not proven to be completely satisfactory, and improved means of operating a shut-off plate on spreaders is needed. It is desirable that a spreader be capable of delivering an accurate amount of fertilizer or other material with repeatable opening and closing of the shut-off plate in any environment.

### SUMMARY

One embodiment of the present disclosure includes a spreader for applying a granulated material or fertilizer where the spreader includes a control gate or shut-off plate operated by a metering rate control system that moves the control gate to facilitate an accurate application of fertilizer from the spreader to the lawn.

In another embodiment of the disclosure, the spreader is operated from a remote location with a remote control device controlling the metering rate control system. In other embodiments, the spreader is operated by a switch that is battery operated and may be foot or hand activated.

Related objects and advantages will become apparent from the description below.

### BRIEF DESCRIPTION OF THE DRAWING

FIG. 1 is a perspective view of a mowing apparatus incorporating a spreader constructed in accordance with an embodiment of the disclosure.

FIG. 2 is a side elevational view of a spreader of the type shown in FIG. 1, illustratively shown as being attached to the rear of a vehicle.

FIG. 3 is a side elevational view of the spreader shown in FIG. 2, illustrating additional details.

FIG. 4 is a top plan cross-sectional view of the spreader shown in FIG. 3, taken along line 4-4.

FIG. 5 is a side elevational cross-sectional view of the spreader shown in FIG. 4, taken along line 5-5.

### DESCRIPTION OF THE ILLUSTRATED EMBODIMENTS

For the purposes of promoting an understanding of the principles of the disclosure, reference will now be made to the embodiments illustrated and specific language will be used to describe the same. It will nevertheless be understood that no limitation of the scope of the disclosure is thereby intended, such alterations, modifications, and further applications of the principles of the disclosure being contemplated as would normally occur to one skilled in the art to which the disclosure relates.

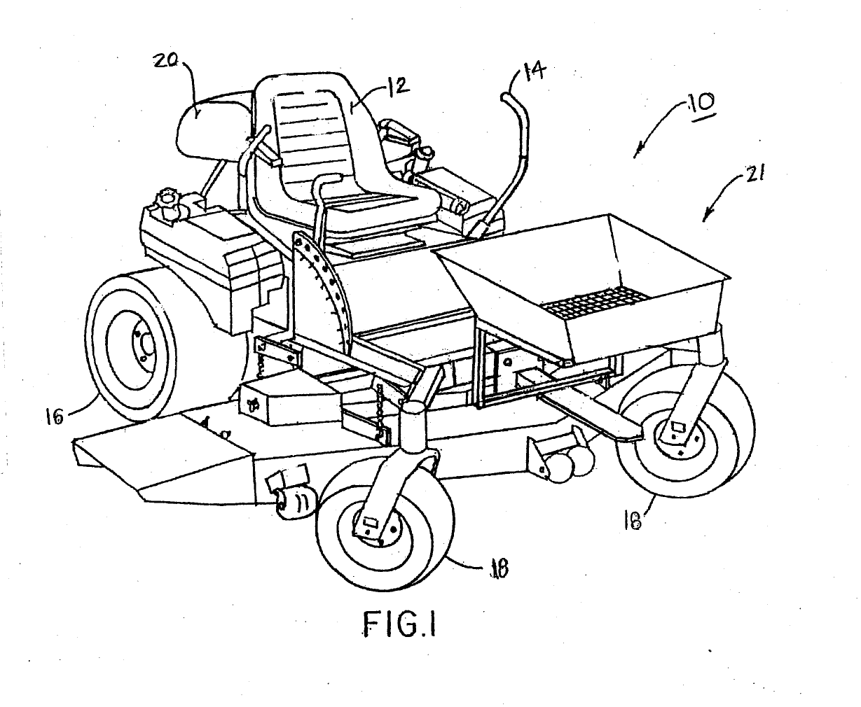

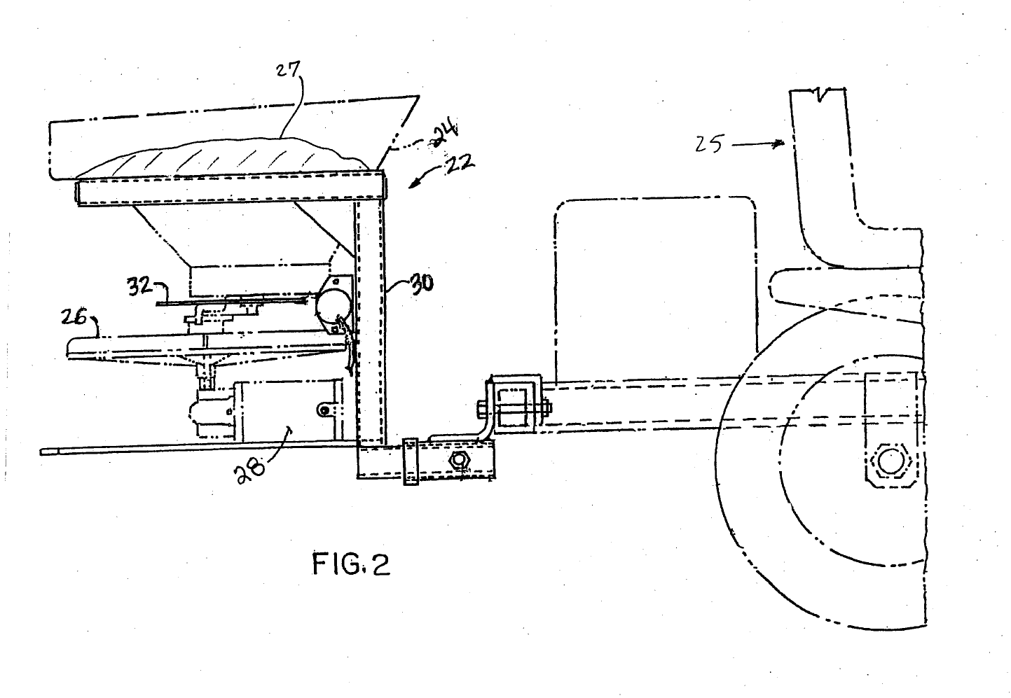

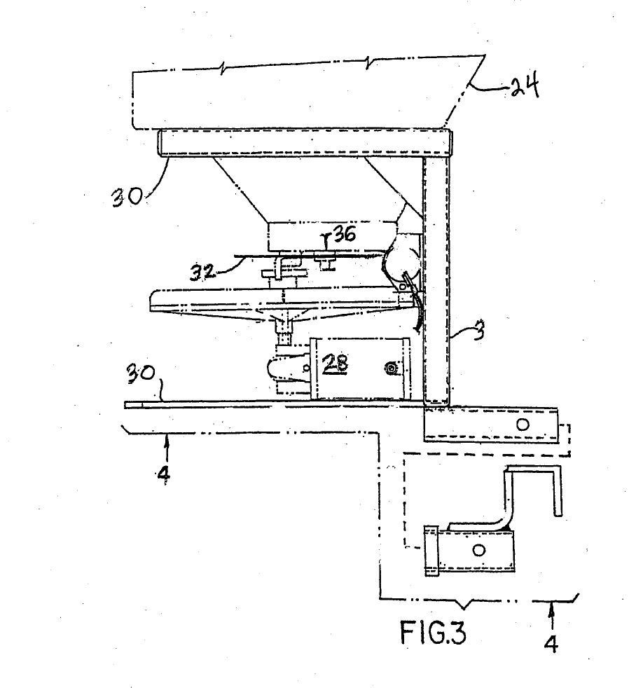

Referring to FIG. 1, there is illustratively shown a zero turning radius riding mower 10, having a seat 12, with a steering control mechanism 14. Mower 10 is illustratively supported by one or more back wheels 16 and one or more front wheels 18. In the embodiment shown, a liquid sprayer 20 is mounted to the back or rear of mower 10 and a spreader 21 is mounted to the front of mower 10. As an example, spreader 21 may be used for the application of granular type fertilizer or seed, as only two non-limiting examples, to the surface of a lawn, although other uses and applications of spreader 21 are of course possible. The construction and operation of spreader 21 will be explained in greater detail with reference to FIGS. 2 through 5.

In the embodiment shown in FIG. 2, a spreader 22 is illustrated as being pulled behind a vehicle 25. The description below with respect to spreader 22 is equally applicable to spreader 21 of FIG. 1 and merely illustrates alternate embodiments of the disclosure.

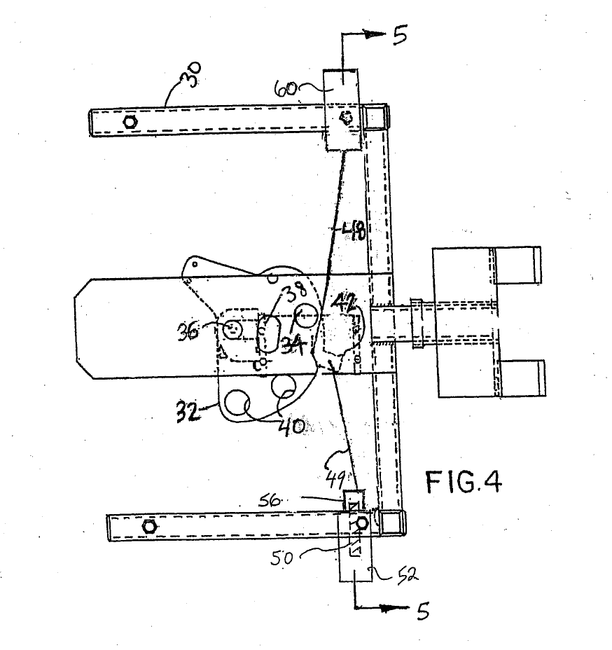

As can be seen in FIG. 2, spreader 22 incorporates a hopper 24 containing a quantity of material 27, which may be fertilizer or seed, as described above, for example. Below hopper 24 are positioned material distribution blades or paddles 26. Distribution blades 26 are operated by a motor 28 which spins blades or paddles 26 to spread or scatter fertilizer or the like as it descends by gravity from hopper 24. Support brackets 30 are shown that structurally support hopper 24 and motor 28. Spreader 22 also incorporates a control gate or shut-off plate 32 located at the underside of hopper 24. As can be seen in FIG. 4, control gate 32 includes a number of apertures. Aperture 34 of control gate 32 provides a pivot point for control gate 32 by pivotally connecting control gate to a mount 36 that extends from the underside of hopper 24 through aperture 34. A clearance slot 38 is also shown as being formed in control gate 32, which allows access for the insertion of an agitator (not shown), which may be utilized to transmit vibrations to hopper 24 to assure that the granular or seed like material in hopper 24 properly flows from hopper 24 to ensure uniform broadcasting of the material. Apertures 40 are designed to align with similarly positioned apertures or discharge ports or holes located in the bottom of hopper 24, so that when control gate 32 is pivoted into an open or operating position, the alignment of these apertures 40 with the openings at the bottom of hopper 24 allows material (e.g., fertilizer) to fall out of hopper 24 for dispersal by blades or paddles 26.

There is also shown a tab 42 to which control cables 48 and 49 are mounted for the purpose of moving and holding control gate 32 between open and closed positions. This assures that proper alignment of the various apertures is made, to allow for proper dispensing or dispersing of the material in hopper 24. Tab 42 and control gate 32 may rotate so as to provide for either full or partial alignment of the apertures 40 with the discharge ports or holes provided at the bottom of hopper 24, so as to control the rate of dispensing of the granular fertilizer or similar material during usage of spreader 22.

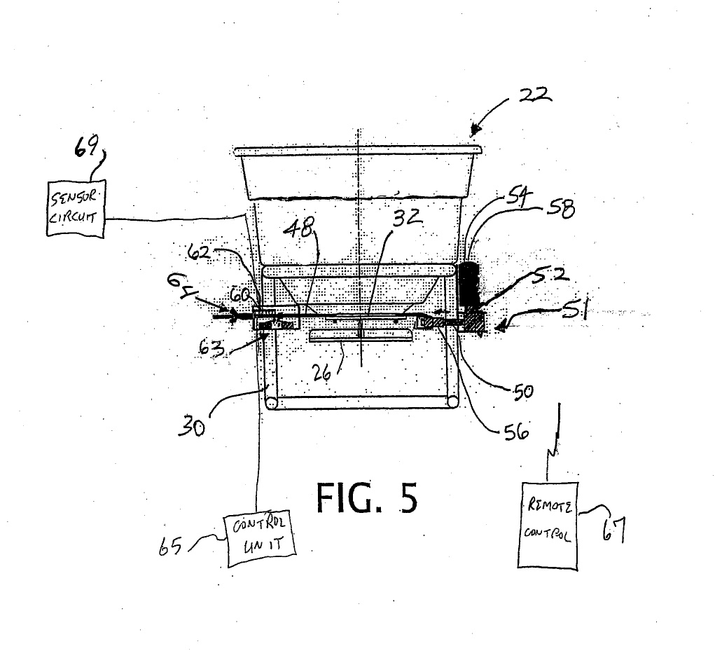

In the illustrated embodiment shown in FIG. 5, control gate 32 is operated by the use of a metering rate control system 51. Metering rate control system 51 incorporates a linear actuator 52 (such as might be used to position seats in vehicles) which comprises a motor assembly 54, rod 50, and collar 56. In one form, linear actuator 52 operates from a 12-volt power supply (e.g., battery or alternator of mower 10 or vehicle 23. As shown, rod 50 is a threaded rod or screw connected to a mating threaded collar 56. Threaded rod 50 is moveable in translational motion relative to both a housing 58 in which motor assembly 54 is mounted or fastened and to collar 56. Collar 56 can be attached to control gate 32 by various means such as by cable 49, for example. Linear actuator 52 and housing 58 are supported by one or more of support brackets 30.

Metering rate control system 51 is illustratively shown as incorporating a potentiometer 60, or other suitable type of transducer, fastened to a second housing 62. Housing 62 is also supported by one or more of support brackets 30. Potentiometer 60 is connected to control gate 32 by cable 48 and operates via one or more switches 63. Switches 63 are illustratively shown as comprising electromechanical contact switches, but other types of switches would of course by equally acceptable. Potentiometer 60 allows a control unit 65 to collect information regarding the position of actuator 52 through a variable control linkage 64. Variable control linkage 64 is connected to control gate 32 via cables 48. Variable control linkage 64 and switches 63 allow control gate 32 to be properly positioned or regulated from a remote location via a handheld remote control device 67, or via a hand or foot-operated mechanism attached to vehicle 25, for example. Variable control linkage 64 receives a signal from potentiometer 60 that in turn provides a control signal to linear actuator 52 and motor assembly 54. A position sensor such as an encoder coupled to linear actuator 52 or to rod 50 may provide a position signal to control linkage 64. Variable control linkage 64 determines the stopping position of motor assembly 54 which translates to a controlled opening of control gate 32. Thus, metering rate control system 51 is able to accurately control the force produced by linear actuator 52 by controlling the stopping position of motor assembly 54 and thus the control gate displacement is able to be accurately determined and maintained. Metering rate control system 51 allows a user to accurately position control gate 32 to control the amount of fertilizer or other material that applied to a lawn surface, for example.

In another embodiment, monitor or feedback sensor circuit or system 69, shown in FIG. 5 as being illustratively coupled to potentiometer 60, may monitor ambient temperature and/or humidity, the moisture content of the material in hopper 24, the granularity of the material, and the actual dispersion rate, to name only a few non-limiting examples, to control the operation of control gate 32 in order to ensure uniform material spreading regardless of weather or other operating conditions of spreader 22.

While the disclosure has been illustrated and described in detail in the drawings and foregoing description, the same is to be considered as illustrative and not restrictive in character, it being understood that only the preferred embodiment has been shown and described and that all changes and modifications that come within the spirit of the disclosure are desired to be protected.

1. A broadcast spreader comprising:
a hopper for holding a quantity of material, said hopper having an aperture through which said material passes;
a dispersion mechanism disposed below said aperture for dispersing said material;
a control gate disposed adjacent to said aperture for controlling the size of said aperture; and
a rate control mechanism for operating said control gate to maintain a uniform dispersion of said material.

2. The broadcast spreader described in claim 1, wherein said rate control mechanism comprises a linear actuator.

3. The broadcast spreader described in claim 1, further comprising sensor circuitry for monitoring at least one of a plurality of conditions for adjusting the operation of said rate control mechanism in response to said conditions.

4. The broadcast spreader described in claim 3, wherein said at least one of said plurality of conditions comprises ambient temperature.

5. The broadcast spreader described in claim 3, wherein said at least one of said of conditions comprises humidity.

6. The broadcast spreader described in claim 3, wherein said at least one of said plurality of conditions comprises moisture content of said material.

7. The broadcast spreader described in claim 3, wherein said at least one of said plurality of conditions comprises the flow rate of said material.

8. A method for operating a broadcast spreader comprising the steps of:
providing a quantity of material in a hopper;
providing an opening in said hopper through which said material flows;
dispersing said material after it flows through said opening; and
automatically controlling the size of said opening in response to a plurality of conditions such that said material is dispersed uniformly independent of said conditions.

9. The method of claim 8, wherein said step of automatically controlling is performed via a linear actuator.

10. The broadcast spreader of claim 1, wherein said material comprises fertilizer.

11. The broadcast spreader of claim 1, wherein said material comprises plant seeds.

12. The broadcast spreader of claim 1, wherein said material comprises weed killer.

13. The broadcast spreader of claim 1, wherein said material comprises insect killer.

14. The broadcast spreader of claim 1, wherein said dispersion mechanism comprises at least one dispersion paddle.

15. The broadcast spreader of claim 1, wherein said rate control mechanism maintains a uniform dispersion of said material independent of changes in environmental conditions.

16. The method of claim 8, wherein said at least one of said plurality of conditions comprises ambient temperature.

17. The method of claim 8, wherein said at least one of said plurality of conditions comprises humidity.

18. The method of claim 8, wherein said at least one of said plurality of conditions comprises moisture content of said material.

19. The method of claim 8, wherein said at least one of said plurality of conditions comprises the flow rate of said material.
